(19) United States
(12) Patent Application Publication
(10) Pub. No.: US 2012/0012609 A1
(43) Pub. Date: Jan. 19, 2012

(54) DISPENSER OF DISPOSABLE PLATES FOR FOOD AND RELATED DISPOSABLE PLATE

(76) Inventors: Stefano Ognissanti, Brugherio (IT); Luca Umberto Rigoni, Monza (IT); Paolo Bau' Castiglioni, Traona (IT)

(21) Appl. No.: 13/258,713

(22) PCT Filed: Apr. 1, 2009
(86) PCT No.: PCT/IT2009/000136

§ 371 Date: Sep. 22, 2011

(51) Int. Cl. B65G 59/06; B65D 21/00

(52) U.S. Cl. 221/290; 206/503

(57) ABSTRACT

A stack of disposable plates for food is describes, in which each plate comprises an upper rim and one or more tabs that depart from said upper rim, towards outside the plate, in which the tabs of a plate of the stack are angularly staggered with respect to the tabs of the adjacent plates of the stack of plates thereof. A dispenser of individual disposable food plates is also described, initially stacked according to the invention. The dispenser comprises a loading platform of a stack of plates, comprising in turn an discharge opening through which the first plate of the stack falls by gravity when separated from the stack and a separating element of the first plate of the stack with respect to the remaining plates of the stack, able to be actuated in rotation by the user.

### FIELD OF THE INVENTION

The present invention refers to a dispenser of disposable plates for food and to a disposable plate associated with it; in particular it refers to a dispenser of single plates for food, of the disposable type, initially stacked, and to a disposable plate intended to be used with such a dispenser.

### PRIOR ART

In the fields of domestic or collective restoration, catering, food packaging, and sale and distribution of food and beverages, disposable containers made from plastic material are widely used, generally plates, bowls, cups and glasses, injection moulded or thermoformed.

Amongst the most widely used disposable glasses there are the ones made in polypropylene PP or in polystyrene PS, having maximum diameter equal to around 70 mm and a maximum capacity equal to about 200 cc. Such glasses each have a weight equal to about 2-3 grams and are suitable for containing cold and hot liquids.

Disposable glasses made in PLA, or rather polylactide made from corn starch (biodegradable) are also available.

In general, the disposable glasses are available in different sizes, capacities, shapes, colours and surface finishing. For example, the disposable glasses can have different heights and diameters, they can have a conical or substantially cylindrical configuration, they can have auxiliary hand grip knurling on the side wall or they can be smooth and they can also be opaque or transparent, etc. . . .

Irrespective of the aforementioned differences, the disposable glasses share the following structural characteristic: the upper rim of each glass is rounded, shaped or turned down on itself so that the users do not cut their lips. This configuration is usually obtained during the manufacturing of the glasses. Initially, the upper rims of the glasses in formation are thin and can potentially be sharp (the rim initially has the same thickness as the side wall of the glass); in a step of the manufacturing process, the upper rim is folded down towards the base of the relative glass and upon itself, thus substantially remaining in abutment with the side surface of the glass.

Consequently the upper rims of the finished glasses have a thickness, or rather have an extension in a radial direction perpendicular to the vertical axis of the glass, which is wider than the thickness of the side wall of the glass itself. In other words, the upper rim protrudes out externally with respect to the side wall of the glass. The rigidity of the upper rim is also greater than the rigidity of the side wall of the glass.

Disposable glasses are normally packaged and marketed stacked. As explained in the following paragraphs, the presence of the thickened and relatively rigid upper rim (in relation to the other portions of the glass) facilitates the separation of a single glass from a stack of disposable glasses, in particular in the circumstance in which the glasses must be withdrawn from manual or automatic dispensers.

In manual dispensers, the stack of glasses is usually loaded inside a container tube; the last glass of the stack remains accessible from outside and can be grasped and pulled by the user. The dispenser comprises one or more flexible tabs which protrude radially out from the inner surface of the container tube forming a bottleneck. The upper rim of the last glass of the stack rests on such a bottleneck; this way the stack of glasses is held vertically to stop it from falling which would otherwise be caused by gravity. In separating the last glass from the stack, the user exerts sufficient force to cause the temporary flexing of the tabs and the disengagement of the upper rim of that glass. Due to elastic recovery of the tabs, the following glass of the stack remains blocked at its upper rim, which is brought into abutment with the flexible tabs themselves which return to the relative undeformed configuration; the other glasses of the stack are supported by this glass. The deformation of the flexible tabs is caused by the interaction of the tabs themselves with the upper rim of the glass extracted from the stack. Such a deformation is therefore possible in virtue of the mechanical rigidity of the upper rim of the glass. The thickening of the upper rim also stops the last glass of the stack from deforming under the weight of the other supported glasses.

In automatic dispensers, the separation of the last glass from the corresponding stack, for example housed in a container tube, is normally obtained by moving a push element. The push element, usually a mechanical finger, is in turn actuated by suitable mechanisms, or else it is motorized. The push element is pushed between the upper rim of the penultimate glass of the stack and the upper rim of the last glass of the stack (the upper rim of a glass is adjacent to the upper rim of the following glass in the stack of glasses) and exerts longitudinal thrust on it, i.e. parallel to the vertical axis of the glass, sufficient to make the two glasses separate. The insertion of the push element between the upper rims of two consecutive glasses of the stack is made easier by the described configuration of the upper rim of each glass. The rigidity of the rim also stops the glass from being damaged or deformed in contact with the push element.

As an example, the manual dispensers of disposable glasses are usually associated with drinking water dispensers located in work places to supply the staff with water. Manual or automatic dispensers are also often associated with automatic beverage dispensers like, for example, machines that dispense coffee, beverages containing coffee, fruit juices, etc. . . .

For the purpose of the present description, by bowl it is meant to identify a container for liquid and/or solid food either hot or cold, the shape of which is similar to that of a plate, but with a greater capacity. For example, a bowl can have the same inner diameter as a plate, but a greater depth/height. From now on, the word plate will be used to indistinctively indicate plates and bowls, dessert plates, small fruit salad bowls, salad bowls, plates for pizza etc. . . .

For example, amongst the most widely used disposable plates there are the ones made in polypropylene PP or in polystyrene PS, having a maximum inner diameter equal to around 200 mm and a thickness between 300 and 500 micron. Disposable plates made in PLA are also available.

Although the disposable plates and glasses are made from the same material and substantially through the same production techniques, there is an important difference between the two types of food containers. Unlike the aforementioned glasses, the plates generally have a substantially sharp upper rim. For the purpose of the present invention, by upper rim we intend to identify the perimeter portion of the plate which protrudes cantilevered from the relative side wall, at the top of the plate, outwards in a substantially radial direction.

Since the plates are not intended for being brought to the mouth of the user, the corresponding production process does not provide particular shaping of the upper rim. In other words, the plates are generally equipped with an upper rim which radially projects outwards, or rather, heading outwards and slightly inclined downwards, but substantially arranged cantilevered, not folded over.

The aforementioned difference makes manual or automatic dispensers for disposable glasses not suitable for use with stacked disposable plates. When the disposable plates are stacked, the relative upper rims are squashed against one another and between them there are no gaps suitable for inserting a push element.

A further difference between the disposable glasses and the disposable plates lies in the fact that the plates are not equipped with surfaces or portions that are easily grasped by the user wanting to separate one plate from the remaining stack.

Normally the stacked disposable plates are separated manually by the staff in charge of the preparation of the table service. For example, in public places in which aperitifs are served, in self-service restaurants, in bars, etc., the staff separate the disposable plates manually, one by one, and place the separate plates, i.e. not stacked, around on the table. In practice, in order to separate a single disposable plate from the corresponding stack, it is necessary to use hands to touch different portions of the plate to be withdrawn and also to handle the rest of the stack of plates; often the staff or the users insert a fingernail between the upper rim of the last plate of the stack, i.e. the plate to be withdrawn, and the upper rim of the penultimate plate of the stack, which instead remains stacked, to lever and separate the plates.

It is desirable to make it possible to avoid the aforementioned handling of the plates in order to not negatively affect hygiene.

### SUMMARY OF THE INVENTION

One purpose of the present invention is therefore that of providing a dispenser of disposable plates for food which allows single disposable plates to be rapidly and easily separated and withdrawn from the relative stack, avoiding direct handling of the plates by the users.

Yet another purpose of the present invention is that of providing a stack of disposable plates for food suitable for being used with the aforementioned dispenser. The present invention therefore concerns, in a first aspect, a stack of disposable plates for food according to claim 1 and, in a second aspect, a dispenser of single disposable plates for food according to claim 3.

In particular, the present invention relates to a stack of disposable plates for food, in which each plate comprises an upper rim and one or more tabs which extend from said upper rim, towards outside the plate, characterized in that the tabs of a plate of the stack are angularly staggered with respect to the tabs of the adjacent plates of the same stack of plates. Preferably each plate of the stack comprises at least two tabs, opposite one another with respect to the plate.

The support base of each plate and the relative side wall are preferably circular. On the other hand, the upper rim of the plates is not circular but has at least two discontinuities, formed by the tabs, which protrude outwards. In the circumstance in which each plate comprises two tabs, these are diametrically opposite one another and angularly staggered by about 90° with respect to the corresponding tabs of an adjacent plate below or above, in the stack of plates.

In the circumstance that each plate comprises more than two tabs, these are evenly distributed on the relative upper rim (with respect to the centre of the plate) and angularly staggered according to angles smaller than 90° with respect to the corresponding tabs of an adjacent plate, below or above, in the stack of plates.

The stack of plates seen in its entirety in plan view, from the top, defines an irregular outline rather than a circular outline, due to the tabs which protrude out from the plates on which they are formed.

The plates which form the stack can be made in a plastic material able to be thermoformed, or rather in wood, in a corn starch based material, etc. . . .

In a second aspect thereof, the present invention relates to a dispenser of single disposable plates for food, initially stacked and having a non-circular upper rim, comprising:
a loading platform for a stack of plates, comprising a discharge opening through which the first plate of the stack falls by gravity when separated from the stack, and
a separating element of the first plate of the stack with respect to the remaining plates of the stack, said separating element comprising a portion which intercepts said discharge opening and vertically supports said stack of plates, in which said intercepting portion extends around a non-circular hole, the inner perimeter of which substantially corresponds to the outer perimeter of each plate of the stack, and in which said separating element is intended to be actuated in rotation around the axis of the hole and with respect to said loading platform to modify the angular position of the hole itself and to make it coincide with the angular position of the first plate of the stack, allowing it to fall through said discharge opening, and
a stop element of the rotation of the plates of said stack with respect to said separating element.

Advantageously, the dispenser according to the present invention makes it possible to easily separate one plate at a time, from the stack of plates loaded into the dispenser, avoiding direct contact between the plate and the user's hands during the separation. In this way, handling of the stack of plates by the users is avoided. Acting upon the separating element, the user separates a single plate from the stack of plates and withdraws only that plate, which has fallen under the loading platform. Every time the separating element is actuated, another plate is separated and distributed.

Preferably each plate of the stack is a plate according to any one of claims 1-2, i.e. a plate equipped with a non-circular outer perimeter. The inner perimeter of the hole of the separating element substantially matches the outer perimeter of each of the plates of the stack, in turn defined by its upper rim and by the relative tabs. When the hole of the separating element is aligned with the first plate of the stack, i.e. with the plate that is the first starting from the bottom and the one closest to the loading platform, such a plate is not supported and falls by gravity through the hole and through the discharge opening. In other words, the tabs of the first plate of the stack are not vertically supported when the inner perimeter of the hole of the intercepting portion coincides with the outer perimeter of the first plate, i.e. when the hole and the plate are aligned. When the hole of the separating element is not aligned with the last plate of the stack, the last plate is supported by the intercepting portion of the separating element at the tabs, and optionally also at part of the outer rim, and remains suspended above the discharge opening.

Preferably the tabs of the first plate of the stack are initially in abutment with the intercepting portion of the separating element and slide on such a portion when the separating element is actuated in rotation by the user. Since the plates are stacked each angularly staggered with respect to the adjacent plates, after the first plate of the stack has fallen, another plate—initially the second starting from the bottom—becomes the new first plate of the stack and the relative tabs rest on the upper surface of the intercepting portion of the separating element; in this configuration the plate is supported at the tabs, and optionally also at its upper rim, and does not fall through the discharge opening. A new operation of the user on the separating element brings the hole of such an element to coincide with the outer perimeter of the new first plate of the stack which falls through the discharge opening.

Preferably the separating element is rotatable with respect to the stack of plates and to the loading platform, alternatively in a clockwise and anti-clockwise direction, to make the inner perimeter of the hole of the intercepting portion coincide at first with the outer perimeter of the first plate of the stack and in a second moment in time with the outer perimeter of a second plate of the stack, adjacent to the first and angularly staggered with respect to it. As previously explained, after the first plate of the stack falls through the hole and the discharge opening, the second plate, initially adjacent to it, moves vertically downwards and becomes the new first plate of the stack. The new first plate rests on the intercepting portion of the separating element at the tabs. The separation of the new first plate is obtained when the user rotates the separating element until the relative hole coincides with the outer perimeter of the new first plate. The described steps are repeated for the remaining plates of the stack, until the stack has run out. The user alternatively rotates the separating element both ways to separate the single plates from the stack loaded into the dispenser according to the invention.

Preferably the dispenser also comprises a covering element of the stack of plates on the loading platform. The covering element is removable to allow the positioning of a new stack of plates onto the loading platform when the previous stack has run out. As an example, the covering element can be a bell which rests over the loading platform or is removably locked on to it.

Preferably, the stop element of the rotation of the stacked plates is fixed to the covering element or housed inside of it. In one embodiment of the present invention, the stop element of the rotation is formed by the inner surface of the covering element.

In a third aspect thereof the present invention concerns an assembly comprising a dispenser of disposable plates according to any one of claims 3-10 and a stack of disposable plates formed by plates according to any one of claims 1-2.

### BRIEF DESCRIPTION OF THE DRAWINGS

Further characteristics and advantages of the invention shall become clear from the following description of some preferred embodiments of the present invention, given hereafter, as an example and not for limiting purposes, with reference to the attached drawings. In such drawings:

FIG. 1a is a perspective view of a first embodiment of a single disposable plate for food suitable for being stacked according to the present invention;

FIG. 1b is a perspective view of a stack of plates according to the present invention, made up of two plates identical to the plate shown in FIG. 1a;

FIG. 1c is a perspective view of a stack of plates according to the present invention, made up of a plurality of plates;

FIG. 2a is a perspective and front view of a first detail of a dispenser of plates according to a first embodiment of the present invention;

FIG. 2b is a perspective and front view of a second detail of the dispenser of plates according to the first embodiment;

FIG. 2c is a perspective and front view of the dispenser of plates according to the first embodiment, partially assembled;

FIG. 3 is a perspective and front view of a third detail of the dispenser of plates according to the first embodiment;

FIG. 4 is a perspective and front view of the dispenser of plates according to the first embodiment, completely assembled;

FIG. 5a is a perspective and front view of the dispenser of plates shown in FIG. 2c, associated with the stack of plates shown in FIG. 1c, and in a first configuration;

FIG. 5b is a perspective and front view of the dispenser of plates shown in FIG. 5a, in a second configuration;

FIG. 5c is a perspective and front view of the dispenser of plates shown in FIG. 5a, in a third configuration;

FIGS. 6a-6e are plan views, from the top and partially transparent, of the dispenser according to the first embodiment, in different configurations during its use;

FIG. 8 is a perspective and front view of the dispenser of plates according to the first embodiment, completely assembled, during its use;

FIG. 9a is a perspective view of a second embodiment of a single disposable plate for food suitable for being stacked according to the present invention;

FIG. 9b is a perspective view of a stack of plates according to the present invention, made up of many plates identical to the plate shown in FIG. 9a;

FIG. 10 is a perspective and front view of the dispenser of plates shown in FIG. 5a, in an operative configuration;

FIG. 11a is a perspective view of a third embodiment of a single disposable plate for food suitable for being stacked according to the present invention;

FIG. 11b is a perspective view of a stack of plates according to the present invention, made up of many plates identical to the plate shown in FIG. 11a;

FIG. 12 is a perspective and front view of a second embodiment of the dispenser of plates of the invention, partially assembled;

FIG. 13 is a perspective and front view of the dispenser of plates shown in FIG. 12, in an operative configuration.

### DETAILED DESCRIPTION OF THE INVENTION

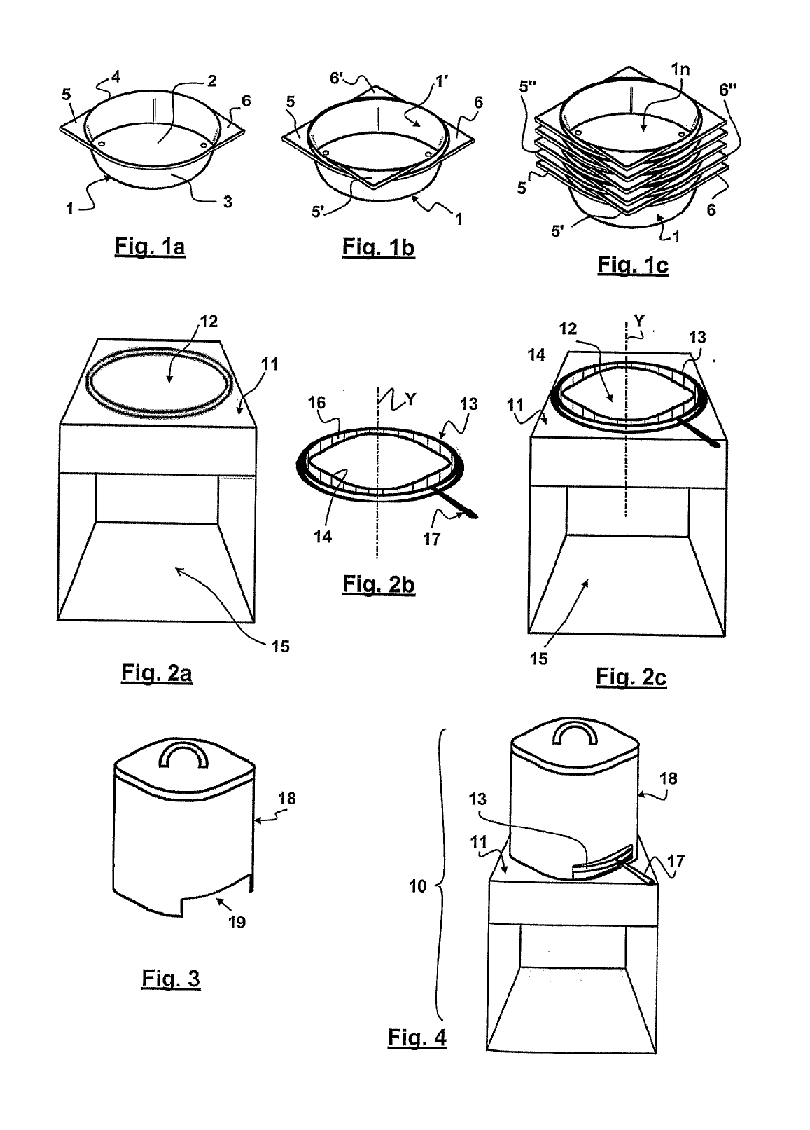

With reference to FIG. 1a, a disposable plate 1 for food is shown, in front perspective and from above, suitable for forming a stack of plates according to the present invention. The plate 1 is preferably of the thermoformed type, in plastic material or in a biodegradable corn starch based material. The plate 1 shown in FIG. 1a comprises a circular support base 2, a side wall 3 which substantially extends out vertically from the perimeter of the circular base 2, and an upper rim 4. Although the support base 2 and the side wall 3 are circular, the upper rim 4 is not circular due to the presence of the tabs 5 and 6 which project outwards from the plate 1, substantially horizontally, starting from the upper rim 4 itself. Generally, the tabs 5 and 6 can have various shapes. In the embodiment shown in FIG. 1a, the tabs 5 and 6 are triangular. Moreover, the tabs 5 and 6 are preferably distributed along the upper rim 4 so as to be diametrically opposite one another with respect to the plate 1.

FIG. 1b shows two stacked plates 1 and 1′. The plate 1′ is identical to the plate 1 shown in FIG. 1a. The plate 1′ is stacked on top of the plate 1 so that the tabs 5′ and 6′ are angularly staggered with respect to tabs 5 and 6 of the underlying plate 1. In the stack formed by the plates 1 and 1′ the corresponding tabs 5, 5′ and 6, 6′ are staggered by around 90° with respect to each other.

For the present description, the plate 1 is the first plate of the stack and the plate 1′ is the second plate.

FIG. 1c shows a stack P of plates according to the present invention; the first plate of the stack P is the plate 1, the second is plate 1′ and the last plate of the stack, starting from the bottom, is the plate 1n. The tabs 5 and 6 of the first plate 1 are angularly staggered by about 90° with respect to tabs 5′ and 6′ of the second plate 1′, which are in turn angularly staggered by about 90° with respect to the corresponding tabs 5″ and 6″ of the third plate 1″, etc. . . . In other words, the tabs 5′, 6′ of a plate 1′ are angularly staggered with respect to the tabs 5 and 6 of the plate 1 and also with respect to the tabs 5″ and 6″ of the plate 1″, or rather with respect to the tabs of the adjacent, previous and following plates, of the stack P.

FIG. 2a is a perspective view, from the front and from the top, of a component of a dispenser of plates according to a first embodiment of the present invention. In particular, FIG. 2a shows a platform 11 onto which the stack of plates P is to be loaded. The loading platform 11 is raised with respect to a compartment 15. The loading platform 11 extends around a discharge opening 12 through which the first plate of the stack P falls when it is separated from the other plates of the stack P.

The loading platform 11 can be made out of different materials, for example, plastic materials, cardboard, wood, etc. . . . and preferably it is made as a single piece with the compartment 15.

The discharge opening 12 shown in FIG. 2a is circular. The diameter of such an opening 12 is greater than the maximum bulk of the plate 1 in plan, or rather, it is greater than the distance between the opposite ends of tabs 5 and 6 of the plate 1. Alternatively, the discharge opening 12 can have different shapes, for example, it can be hexagonal, octagonal, square shaped, etc. . . . In this circumstance, the opening has dimensions such as to allow a plate 1 to pass through it easily.

FIG. 2b shows a separating element 13. Such an element 13 has the function of separating the first plate 1 of the stack P from the remaining plates 1′, 1″, etc. of the same stack P. The separating element 13 comprising an intercepting portion 16 intended to partially intercept the discharge opening 12 of the loading platform 11 and to support the stack P of plates vertically above such an opening 12.

The intercepting portion 16 in turn extends around a non-circular hole 14. The inner perimeter of the hole 14 corresponds to the outer perimeter of each plate 1, 1′, 1″, etc. of the stack P, or rather, the inner perimeter of the hole 14 has the same shape as the outer perimeter of a plate 1, 1′, 1″, etc., but it is slightly wider, in the sense that there is a small gap or clearance between the inner perimeter of the hole 14 and a plate 1, 1′, 1″ inserted in the same hole 14.

The letter Y indicates the axis of the hole 14, or rather the axis passing through the centre of the hole and perpendicular to the plane where the hole 14 is located. The separating element 13 can be made from different materials, for example, wood, metal, cardboard, but preferably it is made from a plastic material.

When the dispenser according to the present invention is assembled, the separating element 13 is able to be actuated in rotation around the axis Y of the hole 14 and with respect to the loading platform 11 to modify the angular position of the hole 14 itself.

FIG. 2c shows a partially assembled dispenser according to the present invention, with the separating element 13 positioned onto the loading platform 11 to partially intercept the discharge opening 12. In practice, the hole 14 of the separating element is coaxial with the discharge opening 12.

As shall be described in more detail in the rest of the description, the separating element 13 is able to be actuated in rotation by the user to rotate the hole 14 around the vertical axis Y so as to make the hole 14 coincide with the angular position of the first plate 1 of the stack P, allowing it to fall through the discharge opening 12. For this reason the separating element 13 is equipped with a handle 17 able to be directly gripped by the user.

FIG. 3 shows a further component; this is a covering element 18 of the stack P of plates on the loading platform 11. The covering element 18 can have different shapes and stops the stack P of plates from falling from the platform 11 or from becoming accidentally dirty.

In the embodiment shown in FIG. 3, the covering element 18 is a bell equipped at the bottom with a door 19 through which the handle 17 extends from the separating element 13. The covering element 18 is able to be fixed to the supporting platform 13 or it can simply rest on its upper surface.

FIG. 4 shows a front perspective view of a dispenser 10 according to the present invention, equipped with the loading platform 11 and with the separating element 13. In addition to these elements, the dispenser 10 is equipped with a stop element of the rotation of the stack P of plates with respect to the platform 11. Generally such an element can be a contrasting element, housed in the covering element 18 or rather fixed to it, laterally pushed against the stack P of plates. Preferably, as shown in FIGS. 3 and 4, the stop element of the rotation of the stack P is formed by the same covering element 18, the inner surface of which extends so that it does not allow any rotation of the plates 1, 1′, 1″, etc. with respect to the axis Y. For example, the inner surface of the covering element 18 matches the outer surface of the entire stack P of plates.

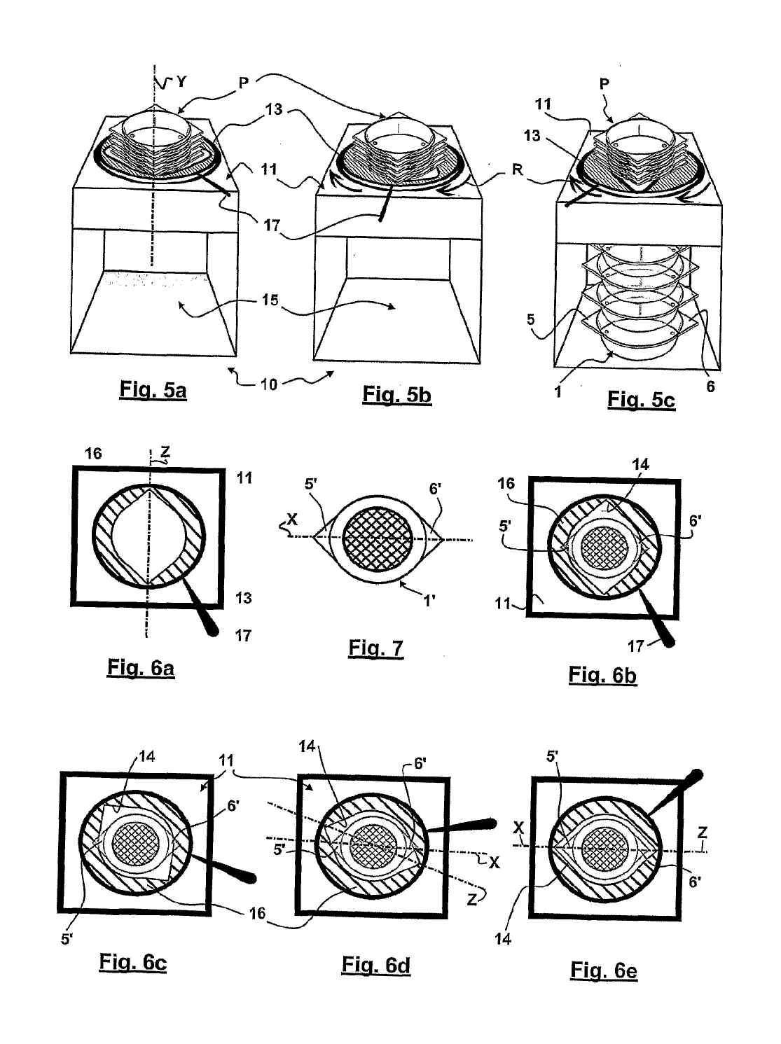

FIGS. 5a-5c show a dispenser 10 while it is operating. The covering element 18 has been omitted to be more clear.

Initially the stack P of plates is loaded onto the separating element 13. The tabs 5 and 6 of the first plate 1 of the stack P rest on the intercepting portion 16 of the discharge opening 12. In practice, the entire stack P of plates is held up by the first plate 1 which rests on the portion 16 of the separating element (FIG. 5a). At a second moment in time the user actuates the handle 17 and rotates the separating element around the axis Y, in a clockwise direction as indicated by the arrow R (FIG. 5b). In this way the hole 14, which is not circular, is brought into alignment with the first plate 1 of the stack P, which in the meantime is kept still with respect to the loading platform 11 by the covering element 18 (not visible). During the relative rotation between the separating element 13 and the stack of plates P, the tabs 5 and 6 of the plate 1 slide over the intercepting portion 16. When the hole 14 is completely aligned with the plate 1, i.e. with its tabs 5 and 6, the plate 1 is not vertically supported by the portion 16 and falls into the compartment 15 through the discharge opening 12 (FIG. 5c).

A rotation opposite to the previous one, or rather in an anti-clockwise direction, brings the hole 14 into alignment with the second plate 1′ of the stack P. When the alignment is completed, the second plate 1″ is also separated from the stack P and falls by gravity into the compartment 15. By alternating clockwise and anti-clock wise rotations of the separating element 13 it is therefore possible to separate single plates 1, 1′, 1″, etc. . . . from the stack P, distributing them to the users one by one. The rotations of the separating element 13 around the axis Y are equal to 90°, i.e. they correspond to the angular staggering of the plates of the stack P loaded onto the platform 11.

FIG. 7 shows the plate 1 in plan. The tabs 5 and 6 are aligned along the horizontal axis X. FIGS. 6a-6e are views from the top, in plan, of the dispenser 10, relative to progressive positions of the separating element 13 with respect to the discharge platform 11 (the covering element 18 has been omitted in order to be clearer). Initially the hole 14 is aligned along the horizontal axis Z (FIG. 6a). The separating element 13 is rotated in an anti-clockwise direction to distribute the plate 1′ (FIGS. 6b-6e) to the user. The rotation of the separating element brings the horizontal axis Z into alignment with the axis X. During rotation the tabs 5′ and 6′ of the plate 1′ slide over the intercepting portion 16 of the separating element 13. The intercepting portion 16 moves under the plate 1′, which on the other hand, remains still with respect to the loading platform 11. Once the hole 14 and the plate 1′ have been aligned, the tabs 5′ and 6′ are not supported by the portion 16 and the plate 1′ falls through the opening 12 into the compartment 15 (FIG. 6e: the axes X and Z coincide). By counter-rotating the separating element 13 in a clockwise direction the plate 1″ is separated, and so on for all the plates of the stack P.

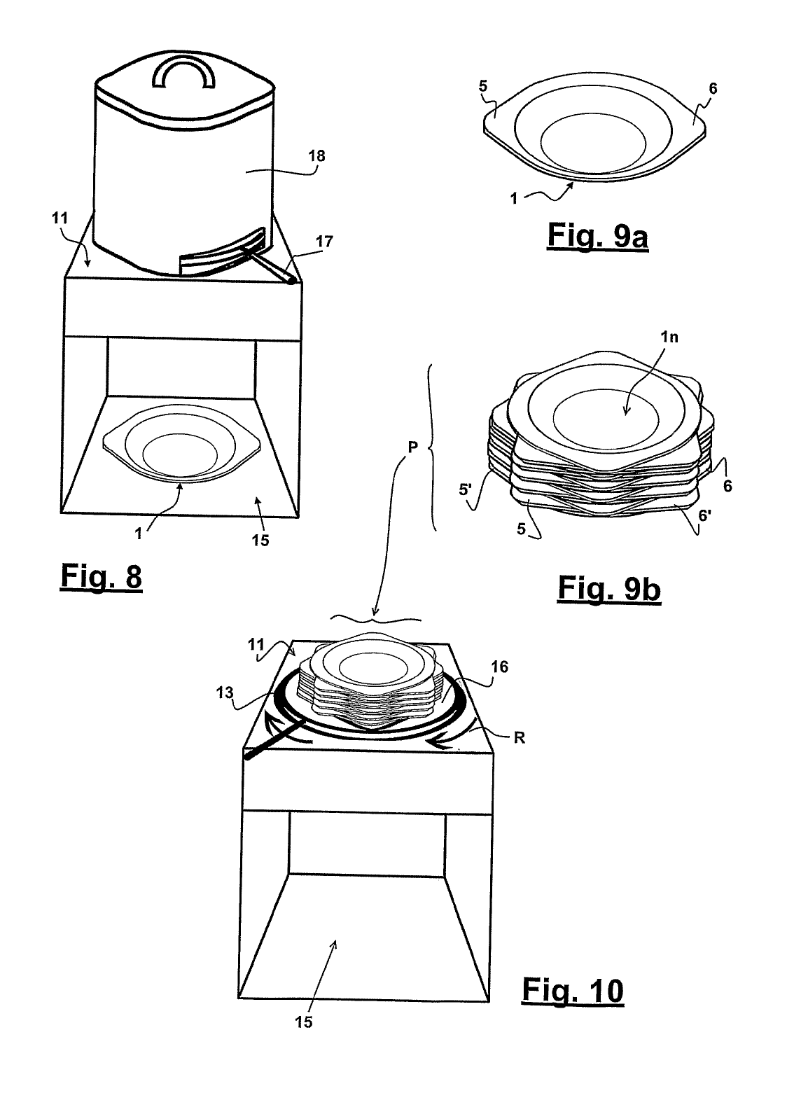

FIG. 8 shows the dispenser 10 in use, with the covering element 18 correctly installed onto the loading platform 11 to cover the stack P and to stop it from rotating with respect to the platform 11 during actuation of the separating element 13.

FIGS. 9a and 9b respectively show a plate 1 with slightly rounded tabs 5 and 6, and a stack P obtained with such a plate. It should be clear that in the stack P shown in FIG. 9b the angular staggering of the tabs 5, 6 of a plate 1 with respect to the corresponding tabs 5′, 6′ of an adjacent plate 1′ is under 90°: the staggering is equal to around 60°. Despite the different configuration of the stack P shown in FIG. 9b compared to the stack P shown in FIG. 1c, the dispenser 10 does not need modifications: the separating element 13 remains identical.

FIG. 10 shows the dispenser 10 in association with the stack P of plates shown in FIG. 9b. Since the plates 1, 1′, . . . 1n of the stack are angularly staggered by around 60°, the rotation of the separating element 13 needed to separate the plates corresponds to 60° (lower than that relative to the configuration shown in FIGS. 5a-5c and 6a-6e).

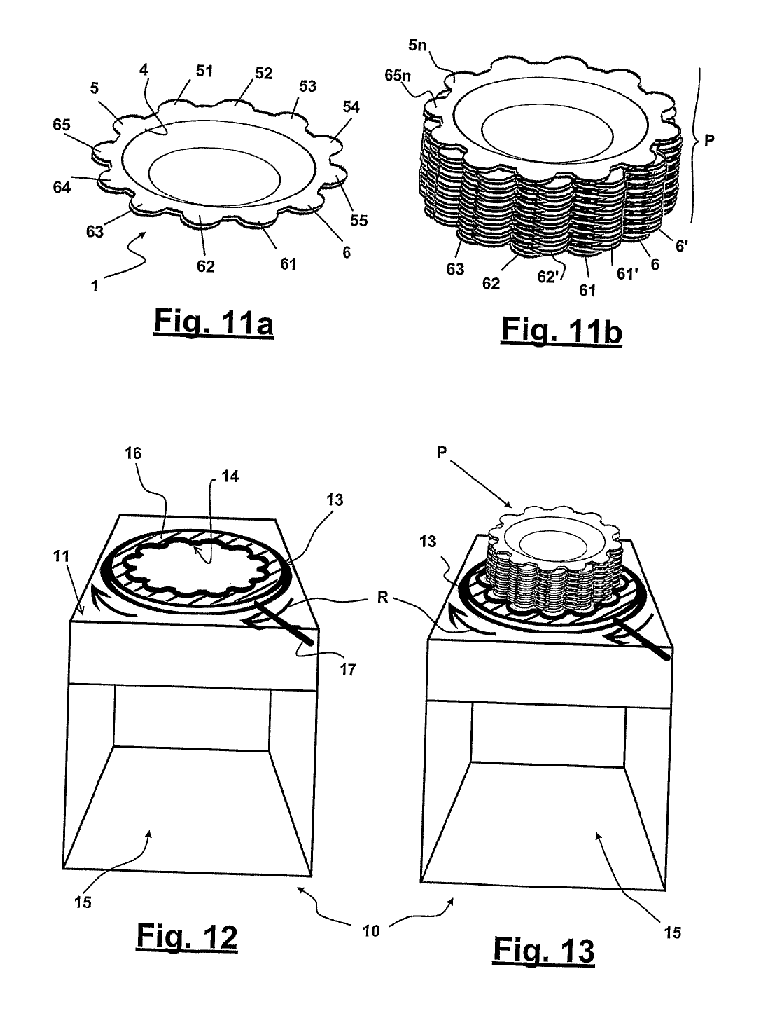

FIG. 11a shows another embodiment of the plate 1, equipped with a plurality of tabs 5, 51-55 and 6, 61-65, uniformly arranged along the upper rim 4 of the plate, according to a “daisy-shaped” profile. FIG. 11b shows a stack P of plates according to the present invention, formed with a plurality of plates 1 identical to that shown in FIG. 11a. In this case the plates of the stack P are angularly staggered by a few degrees, about 5°-10°.

FIGS. 12 and 13 respectively show the dispenser 10 suitable for functioning with the stack P of plates shown in FIG. 11 (the covering element has been removed). The inner perimeter of the hole 14 of the separating element 13 substantially corresponds to the outer perimeter of each plate of the stack P, apart from the aforementioned gap. Since the angular staggering between the plates 1, 1′, . . . 1n of the stack P shown in FIGS. 11b and 13 is between 5° and 10°, the rotation of the separating element 13 is also between 5° and 10° to obtain the separation of the first plate 1 of the stack P and its feeding into the compartment 15.

The dispenser 10 of disposable plates allows single plates 1, 1′, . . . 1n to be easily separated from a stack P of plates loaded onto the platform 11, by simply rotating the separating element 13 through the relative handle 17. There is therefore no direct handling of the stack P by the users, all to the advantage of hygiene.

The handle 17 can be replaced with an electric motor able to be actuated by the user through a push button.

The dispenser 10 of plates can advantageously be used in bars, in night clubs that have aperitifs, in canteens and in self-service restaurants, etc. . . .

1-2. (canceled)

3. A dispenser of single disposable food plates, initially stacked and having an upper non-circular rim, comprising:
a loading platform of a stack of plates, comprising a discharge opening through which the first plate of the stack falls by gravity when separated from the stack, and
a separating element of the first plate of the stack with respect to the remaining plates of the stack, said separating element comprising a portion which intercepts said discharge opening and vertically supports said stack of plates, wherein said intercepting portion extends around a non-circular hole the inner perimeter of which substantially corresponds to the outer perimeter of each plate of the stack, and wherein said separating element is able to be actuated in rotation around the axis of the hole and with respect to said loading platform to modify the angular position of the same hole and to make it coincide with the angular position of the first plate of the stack, allowing it to fall through said discharge opening, and
a stop element of the rotation of the plates of said stack with respect to said separating element.

4. The dispenser according to claim 3, wherein each plate of the stack comprises an upper rim and one or more tabs which depart from said upper rim, towards outside the plate, wherein the tabs of a plate of the stack are angularly staggered with respect to the tabs of the adjacent plates of the same stack of plates, and wherein the inner perimeter of said hole substantially copies the outer perimeter of each of the plates of the stack, the outer perimeter of a plate being defined by its upper rim and by the relative tabs.

5. The dispenser according to claim 4, wherein the tabs of the first plate of the stack are initially in abutment with said intercepting portion and run on the same intercepting portion when the separating element is actuated in rotation.

6. The dispenser according to claim 4, wherein the tabs of the first plate of the stack and the relative upper rim are not supported by said intercepting portion when the inner perimeter of said hole coincides with the outer perimeter of the first plate.

7. The dispenser according to claim 3, wherein said separating element is rotatable with respect to said stack of plates and to said loading platform, alternatively in a clockwise and anticlockwise direction, to make the inner perimeter of said hole coincide at a first moment in time with the outer perimeter of the first plate of the stack, and at a second moment in time with the outer perimeter of a second plate of the stack, adjacent to the first plate and angularly staggered with respect to it.

8. The dispenser according to claim 3, also comprising a covering element of said stack of plates on said loading platform, the covering element being removable so as to allow the stack of plates to be positioned on the loading platform.

9. The dispenser according to claim 8, wherein said stop element of the rotation is fastened to said covering element or housed inside of it.

10. The dispenser according to claim 8, wherein said stop element of the rotation consists of the inner surface of said covering element.

11. An assembly comprising a dispenser of disposable plates according to claim 3 and a stack of disposable plates, wherein each plate comprises an upper rim and one or more tabs which depart from said upper rim, towards outside the plate, wherein the tabs of a plate of the stack are angularly staggered with respect to the tabs of the adjacent plates of the same stack of plates.
